(19) United States
(12) Patent Application Publication
(10) Pub. No.: US 2012/0182324 A1
(43) Pub. Date: Jul. 19, 2012

(54) DISPLAY CONTROL APPARATUS AND CONTROL METHOD THEREOF

(75) Inventor: Tomohiro Yano, Yokohama-shi (JP)

(73) Assignee: CANON KABUSHIKI KAISHA, Tokyo (JP)

(21) Appl. No.: 13/339,265

(22) Filed: Dec. 28, 2011

(30) Foreign Application Priority Data
Jan. 17, 2011 (JP) 2011-007157

(51) Int. Cl. G09G 5/34

(52) U.S. Cl. 345/684

(57) ABSTRACT

A display control apparatus is provided that allows a user to easily continue a scroll operation while making the user recognize a particular position when the particular position is reached during the scroll operation. The display control apparatus controls a display unit to display a display object in a particular order and, further performs control to scroll the displayed display object by a movement amount according to an operation amount of an operation member which is a touch sensor or a rotation operation member. During the control, the display control apparatus determines the movement amount the display object is scrolled so that the movement amount according to the operation amount is smaller when the particular position, a break in the particular order, is included in the displayed screen than when the particular position is not included.

### BACKGROUND OF THE INVENTION

1. Field of the Invention

The present invention relates particularly to a display control apparatus, a display control apparatus control method, and a storage medium storing therein a program that are advantageously usable for scrolling a display object.

2. Description of the Related Art

Conventionally, several members are widely used on a display apparatus with the scroll interface. Among these are an operation member that is used to specify a direction, a rotation member that allows a user to select a desired candidate quickly, and a member, such as a touch sensor, that allows the user to enter data continuously. A display apparatus is known that has these input members and that, when the user scrolls the display to the end of the items and attempts to further scroll the display into the end direction, moves the display to the opposite end so that the display items can be displayed cyclically. One of the issues with the scroll operation on such a display apparatus is that the user sometimes does not notice that the last display item is displayed and once-displayed items are displayed again before he or she knows.

To solve this issue which is especially apparent on a display apparatus with the rotation member that facilitates continuous input, several methods have been discussed to explicitly indicate that the last display item has been reached when the user attempts to scroll at a particular point, for example, at the end of the items or at the end of the images. As a conventional scroll interface, Japanese Patent Application Laid-Open No. 2006-252366 discusses a scroll interface in which the user scroll operation is suspended for a longtime at a break point, for example, at the end of the items. Japanese Patent Application Laid-Open No. 2008-71165 discusses a method in which the display moves from one end of images to the opposite end thereof when a particular condition is satisfied, for example, when the same operation is repeated three or more times.

However, the method discussed in Japanese Patent Application Laid-Open No. 2006-252366 generates a predetermined time period during which the user operation is not accepted, requiring the user to repeat the scroll operation at the end of the items. In addition, this method prevents the user from performing a continuous scroll operation and so, once the scroll operation attempted by the user does not scroll the display, the user feels as if the display could not be scrolled any more. With the method discussed in Japanese Patent Application Laid-Open No. 2008-71165, the user can scroll forward by performing a special operation at the end of the images. However, this method must explicitly notify the user that a special operation is required.

### SUMMARY OF THE INVENTION

The present invention is directed to a technique that allows a user to easily continue a scroll operation while making the user recognize a particular position when the particular position is reached during the scroll operation.

A display control apparatus includes a display control unit configured to control a display unit to display a display object in a particular order, a scroll control unit configured to perform control to scroll the display object displayed by the display control unit by a movement amount according to an operation amount of an operation member which is a touch sensor or a rotation operation member, and a determination unit configured to determine the movement amount in the scrolling which is controlled by the scroll control unit so that the movement amount according to the operation amount is smaller in a case where a particular position as a break in the particular order is included in a screen displayed on the display unit than in a case where the particular position is not included therein.

According to an aspect of the present invention, a display control apparatus allows a user to easily continue a scroll operation while making the user recognize a particular position when the particular position is reached during the scroll operation. Accordingly, the display control apparatus can eliminate the need for the user to retry the operation or to perform a special operation different from the normal operation at a particular position such as the end of the screen.

This summary of the invention does not necessarily describe all necessary features so that the invention may also be a sub-combination of these described features. Further features of the present invention will become apparent from the following description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of an internal configuration of a digital video camera according to an exemplary embodiment of the present invention.

FIG. 2 is a perspective diagram illustrating an example of an outline configuration of the digital video camera according to the exemplary embodiment.

FIG. 3 is a flowchart illustrating an example of procedures for scrolling according to a first exemplary embodiment.

FIG. 4 is a conceptual diagram illustrating an example of an arrangement of images.

FIG. 5 illustrates an example of a display screen of a liquid crystal panel.

FIG. 6 illustrates an example of a display screen of the liquid crystal panel when a particular point is included.

FIGS. 7A to 7F are diagrams conceptually illustrating a scroll movement amount.

FIG. 8 is a flowchart illustrating an example of procedures for scrolling according to a second exemplary embodiment.

FIGS. 9A to 9C illustrate an example of scrolling when a drag operation is performed.

FIG. 10 is a flowchart illustrating an example of procedures for scrolling according to a third exemplary embodiment.

FIGS. 11A and 11B illustrate an outline of scrolling according to a third exemplary embodiment.

FIGS. 12A and 12B illustrate an example of the display when a blank is inserted at a particular point according to a fourth exemplary embodiment.

### DESCRIPTION OF THE EMBODIMENTS

Various exemplary embodiments, features, and aspects of the invention will be described in detail below with reference to the drawings. It is to be noted that the following exemplary embodiments are merely one example for implementing the present invention and can be appropriately modified, combined, or changed depending on individual constructions and various conditions of apparatuses to which the present invention is applied. Thus, the present invention is in no way limited to the following exemplary embodiments.

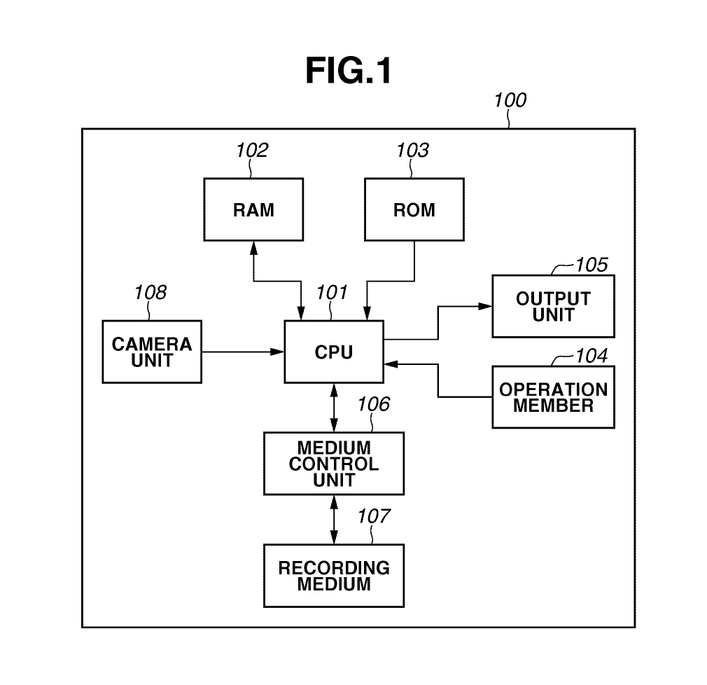

FIG. 1 is a block diagram illustrating an example of an internal configuration of a digital video camera 100 according to a first exemplary embodiment.

In FIG. 1, a central processing unit (CPU) 101, which functions as a system control unit, controls the digital video camera 100 in its entirety. A random access memory (RAM) 102 may be a static random access memory (SRAM) and a dynamic random access memory (DRAM), and stores program control variables and so on. The RAM 102 further stores various setting parameters, various work buffers, and so on. A read only memory (ROM) 103 stores the control program of the CPU 101 and various fixed data pieces.

An operation member 104 may include a touch sensor that accepts scroll input, a zoom bar, and an imaging start/stop button, and so on. An output unit 105 may include a liquid crystal panel, a speaker, and so on, and the touch sensor of the operation member 104 is stuck on the liquid crystal panel.

A medium control unit 106 controls a removable recording medium 107 to read and write data to and from the recording medium 107. The recording medium 107 may be such as a hard disk and a memory card to and from which data is read and written under control of the medium control unit 106.

A camera unit 108 may include a sensor such as a charge coupled device (CCD) sensor or a complementary metal oxide semiconductor (CMOS) sensor and a camera lens, which are required for imaging and image forming, a member such as a microphone required for audio recording, and an encoding device that encodes image data and audio data into a predetermined compressed format. Using these members, the camera unit 108 captures a moving image and a still image.

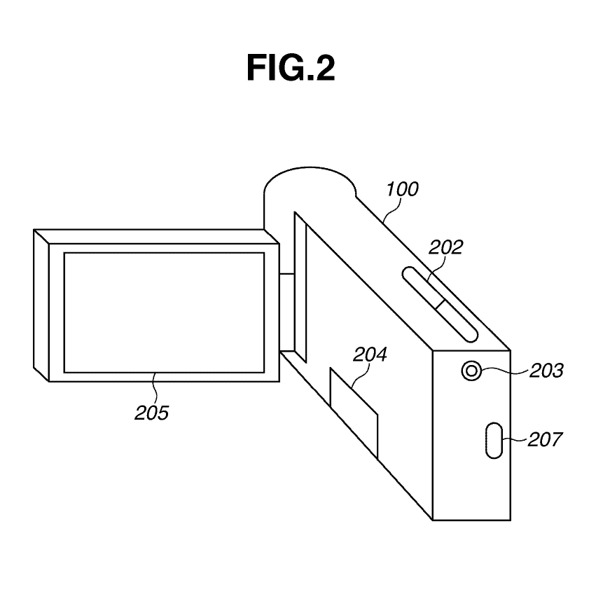

FIG. 2 is a perspective diagram illustrating an example of an outline view of the digital video camera 100 in the present exemplary embodiment.

In FIG. 2, a zoom lever 202 is an operation member that operates the lens of the camera unit 108 to change an angle of view continuously. An imaging start/stop button 203 starts imaging when pressed at non-imaging time, and stops imaging when pressed at imaging time. A medium insertion unit 204 is a unit into which the recording medium 107 is inserted. A touch sensor is stuck on a liquid crystal panel 205. A power switch 207 is a button that turns on and off the main power of the digital video camera 100.

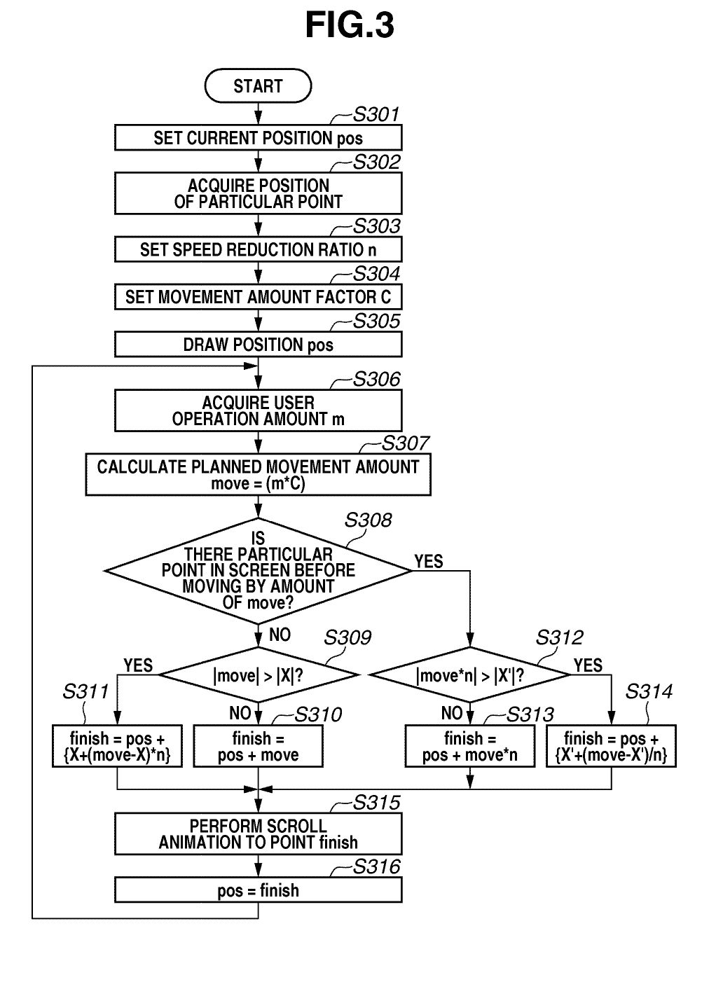

Referring to FIG. 3, the following describes the scroll display processing performed via a touch button operation on the digital video camera 100.

FIG. 3 is a flowchart illustrating an example of processing procedures for performing a scroll display on the digital video camera 100. The processing illustrated in FIG. 3 is executed by control of the CPU 101. The scroll display processing of the digital video camera 100 includes the display of, for example, a screen on which a list of captured images is displayed and a menu screen via which the user specifies settings for the digital video camera 100 at imaging time.

Although the screen on which the list of captured images (for example, thumbnail images) is displayed is used as an example in the present exemplary embodiment, the procedure similar to that described in the present exemplary embodiment maybe commonly used for scrolling a screen on which a plurality of items is displayed. Although the touch buttons displayed on the liquid crystal panel 205 are used for the scroll processing in the present exemplary embodiment, the similar procedure is used also for scrolling by an arrow key button operation.

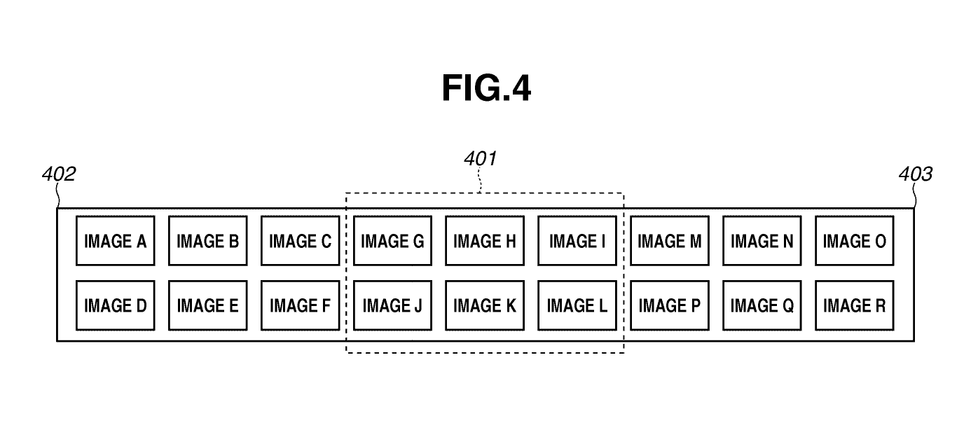

When a user operates the operation member 104 and inputs an instruction to display a list of images, the CPU 101 starts processing. First, in step S301, the CPU 101 determines a position “pos” that indicates a position of the images to be displayed. FIG. 4 is a conceptual diagram illustrating how the images, which are recorded on the recording medium 107, are arranged for display on the liquid crystal panel 205 included in the output unit 105. In FIG. 4, images A to R are recorded on the recording medium 107. An area 401 indicates a range displayed on the liquid crystal panel 205. In step S301, the CPU 101 determines the area to be displayed from the images A to R, which are arranged as illustrated in FIG. 4.

Next, in step S302, the CPU 101 acquires position information about a particular point. The particular point is, for example, a leading end 402 and a trailing end 403 of the images illustrated in FIG. 4. When the scroll operation is performed, the leading end 402 and the trailing end 403 are displayed continuously.

Next, in step S303, the CPU 101 sets a scroll speed reduction ratio n. More specifically, the CPU 101 sets the speed reduction ratio n to 1/5, for example. The speed reduction ratio refers to the ratio of speed at which the screen will be scrolled at a reduced speed than the usual operation. The value of the speed reduction ratio n is not limited to 1/5, and the user may set the value to an arbitrary value in advance.

Next, in step S304, the CPU 101 sets a movement amount factor C. The movement amount factor C is a value indicating the amount of scroll on the liquid crystal panel 205 with respect to a displacement 1 of the scroll operation performed by the user. In the present exemplary embodiment, a scroll amount corresponding to one screen is set as the movement amount factor C. The movement amount factor C is not limited to one screen, and the user may set the movement amount factor C to an arbitrary value in advance.

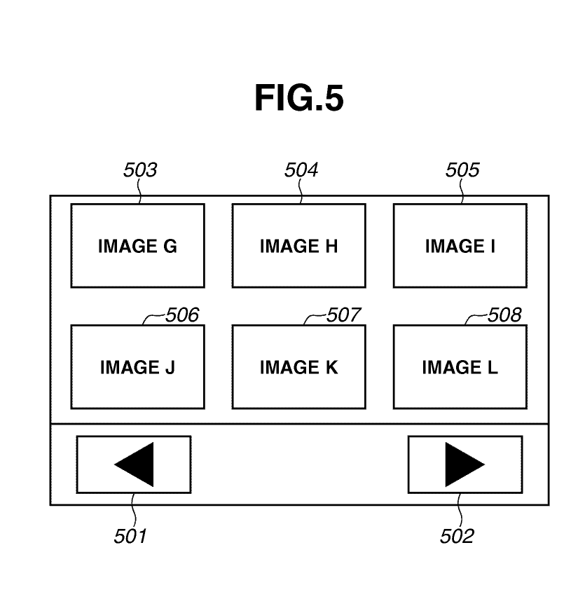

Next, in step S305, the CPU 101 draws the position “pos” that is set in step S301. As illustrated in FIG. 5, the CPU 101 displays the list of images included in the area indicated by the position “pos”. In the example illustrated in FIG. 5, when the user touches one of images 503 to 508, the corresponding moving image is selected and its reproduction is started.

Next, in step S306, the CPU 101 acquires information about a user operation amount m input via the operation member 104. For example, when the user touches a left arrow button 501 in FIG. 5 once, the operation amount is counted as m=−1, conversely, when the user touches aright arrow button 502 once, the operation mount is counted as m=+1. When the user holds down the left arrow button 501 or the right arrow button 502, the operation amount m is counted down or up by 1 at a periodic interval.

Next, in step S307, the CPU 101 calculates a planned movement amount “move” by multiplying the operation amount m by the movement amount factor C. In step S308, the CPU 101 determines whether a particular point is included in the screen on the liquid crystal panel 205 displayed in step S305 or step S316, which is described below.

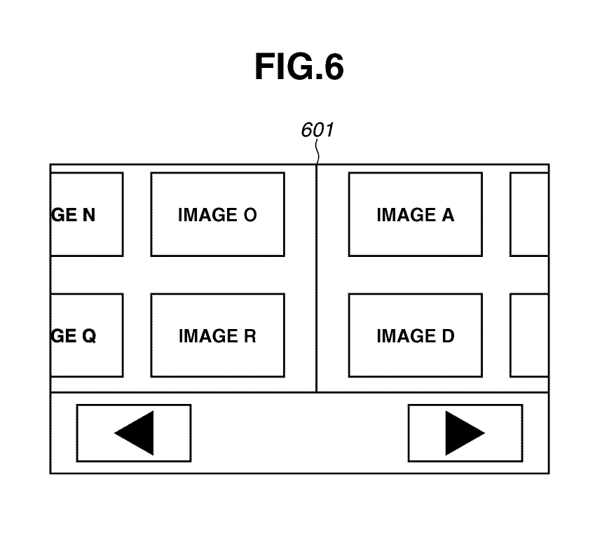

If the CPU 101 determines that the particular point is not included in the screen (NO in step S308), the CPU 101 advances the processing to step S309. The particular point is considered to be included in the screen, for example, when a break between the trailing end 403 and the leading end 402 is displayed as a particular point 601 in the screen, as illustrated in FIG. 6, during the scroll control operation in which the images are displayed cyclically.

Next, in step S309, the CPU 101 calculates a distance X from the end of the currently displayed screen in the movement direction side to the particular point and determines whether an absolute value of the planned movement amount “move” is larger than an absolute value of the distance X. The distance X is calculated based on the position information of the particular point acquired in step S302 and, if the operation amount m<0, the distance X is negative.

If it is determined that the absolute value of the planned movement amount “move” is smaller than or equal to the absolute value of the distance X (NO instep S309), then in step S310, the CPU 101 acquires information about an actual movement destination “finish” from the planned movement amount “move” calculated in step S307. At this time, the CPU 101 acquires information about the movement destination “finish” by adding the planned movement amount “move” to the position “pos”.

Meanwhile, in step S309, if it is determined that the absolute value of the planned movement amount “move” is larger than the absolute value of the distance X (YES in step S309), then in step S311, the CPU 101 acquires the information about the movement destination “finish” from expression (1) given below.

finish=pos+{X+(move−X)*n} Expression (1)

On the other hand, in step S308, if it is determined that the particular point is included in the screen (YES in step S308), the CPU 101 advances the processing to step S312. In step S312, the CPU 101 calculates a distance X′ that is a distance over which the screen will move until the particular point goes out of the screen. The CPU 101 calculates the distance X′ based on the position information of the particular point acquired in step S302. When the operation amount m<0, the value of the distance X′ is negative. After that, the CPU 101 determines whether an absolute value of the product of the planned movement amount “move” and the speed reduction ratio n is larger than an absolute value of the distance X′.

If it is determined that the absolute value of the product of the planned movement amount “move” and the speed reduction ratio n is smaller than or equal to the absolute value of the distance X′ (NO in step S312), the CPU 101 advances the processing to step S313. In step S313, the CPU 101 acquires the information about the movement destination “finish” by adding the value, which is calculated by multiplying the planned movement amount “move” by the speed reduction ratio n, to the position “pos”.

On the other hand, if it is determined that the absolute value of the product of the planned movement amount “move” and the speed reduction ratio n is larger than the absolute value of the distance X′ (YES in step S312), the CPU 101 advances the processing to step S314. In step S314, the CPU 101 acquires the information about the movement destination “finish” according to expression (2) given below.

finish=pos+{X′+(move−X′/n)} Expression (2)

Next, in step S315, the CPU 101 starts scroll animation to the movement destination “finish”, which is acquired in one of steps S310, S311, S313, and S314, in a predetermined time. In step S316, the CPU 101 replaces the current position “pos” with the position of the movement destination “finish”. The CPU 101 returns the processing to step S306 to repeat these operations.

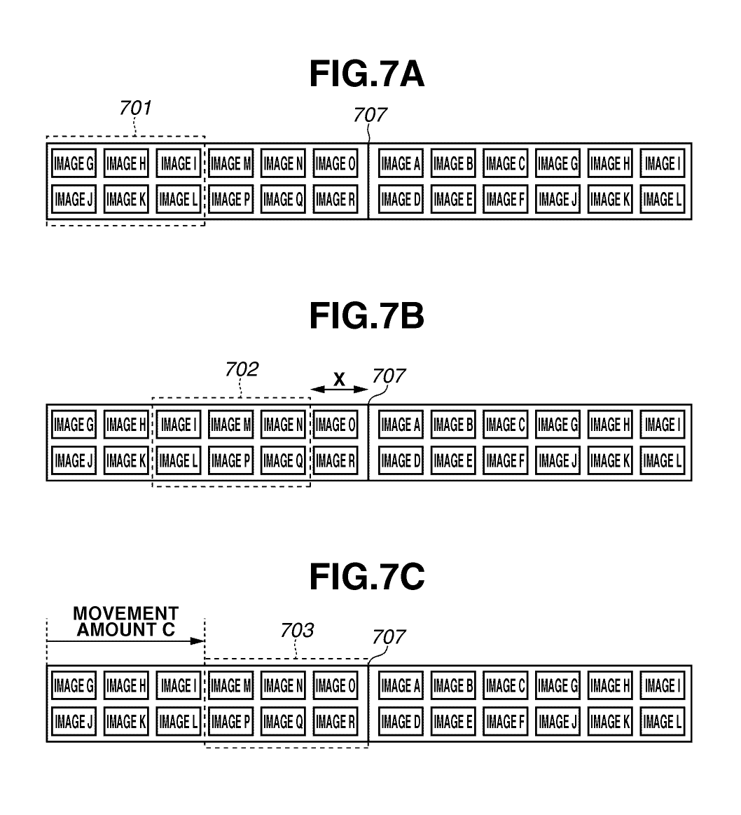

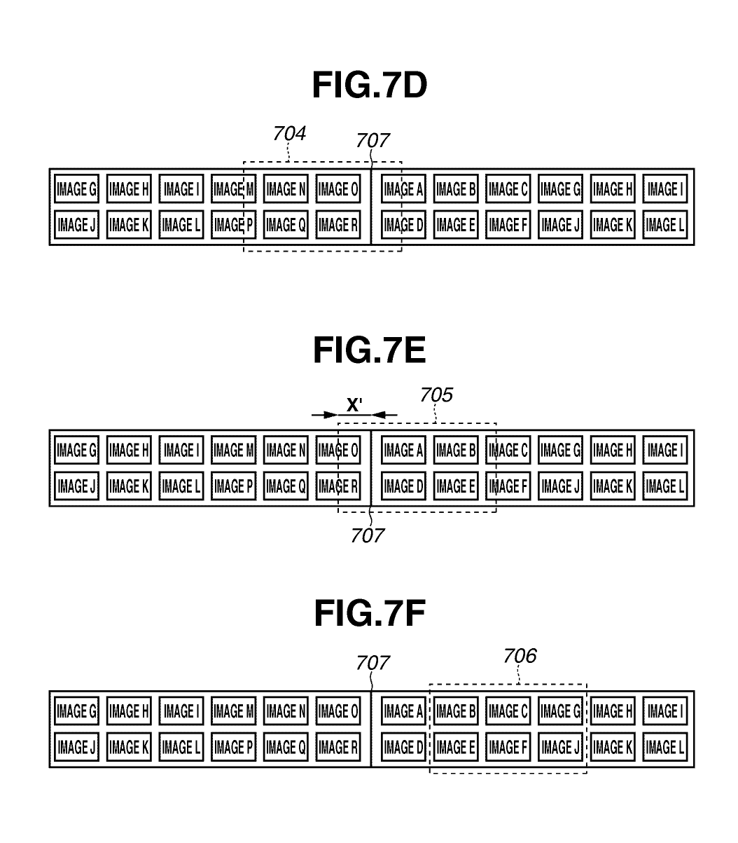

Next, the following describes the processing in steps S310, S311, S313, and S314 in detail with reference to FIGS. 7A to 7F. FIGS. 7A to 7F illustrate the relation between the arrangement of the images displayed on the screen and the position of the screen.

The CPU 101 advances the processing to step S310 in such a case that, when the user touches the right arrow button 502 while a screen 701 in FIG. 7A is displayed, the screen scrolls to a screen 703 illustrated in FIG. 7C. Because a particular point 707 is not displayed in the moved screen 703 by the processing of this operation, the scroll position determined by shifting one screen, which is the movement amount factor C determined in step S304, is set as the movement destination “finish”. Accordingly, in step S315, the scroll animation is performed from the screen 701 to the screen 703.

The CPU 101 advances the processing to step S311 in such a case that, when the user touches the right arrow button 502 while a screen 702 in FIG. 7B is displayed, the screen scrolls to a screen 704 illustrated in FIG. 7D. In this case, the screen scrolls to the particular point at a normal speed and, after the particular point is included in the screen, at a reduced speed according to the speed reduction ratio n.

In addition, the CPU 101 advances the processing to step S313 in such a case that, when the user touches the right arrow button 502 while the screen 703 in FIG. 7C is displayed, the screen scrolls to the screen 704 illustrated in FIG. 7D.

In step S308, if the particular point overlaps with the end of the screen on the side of the movement direction (right end of the screen 703 in the example illustrated in FIG. 7C), the CPU 101 determines that the particular point is included in the screen. On the other hand, if the particular point overlaps with the end of the screen on the opposite side of the movement direction (left end of the screen 703 in the example illustrated in FIG. 7C), the CPU 101 determines in step S308 that the particular point is not included in the screen. This means that, in step S313, the screen scrolls past the particular point 707 during the scroll operation and, therefore, the scroll position calculated by multiplying the movement amount factor C, which is the scroll amount corresponding to one screen determined in step S304, by the speed reduction ratio n, which is set in step S303, is set as the movement destination “finish”.

The CPU 101 advances the processing to step S314 in such a case that, when the user touches the right arrow button 502 while a screen 705 in FIG. 7E is displayed, the screen scrolls to a screen 706 illustrated in FIG. 7F. In this case, the screen scrolls at a reduced speed while the particular point is included in the screen, and at the normal speed when the particular point goes out of the screen.

As described above, the screen scrolls at the reduced speed in the present exemplary embodiment when a particular position such as the particular point is displayed in the display screen. Thus, the present exemplary embodiment allows the user to scroll the screen with no need to perform the operation again or to perform a special operation.

The following describes a second exemplary embodiment of the present invention. The first exemplary embodiment describes an example in which the operation is performed using the buttons displayed on the liquid crystal panel 205, while the second exemplary embodiment describes an example in which an operation is performed by dragging an image displayed on the liquid crystal panel 205. More specifically, the scroll operation is performed in such a way that the image follows a pen for dragging the image. The configuration of a digital video camera according to the present exemplary embodiment is similar to the digital video camera illustrated in FIG. 1 and FIG. 2 and therefore the description thereof is omitted.

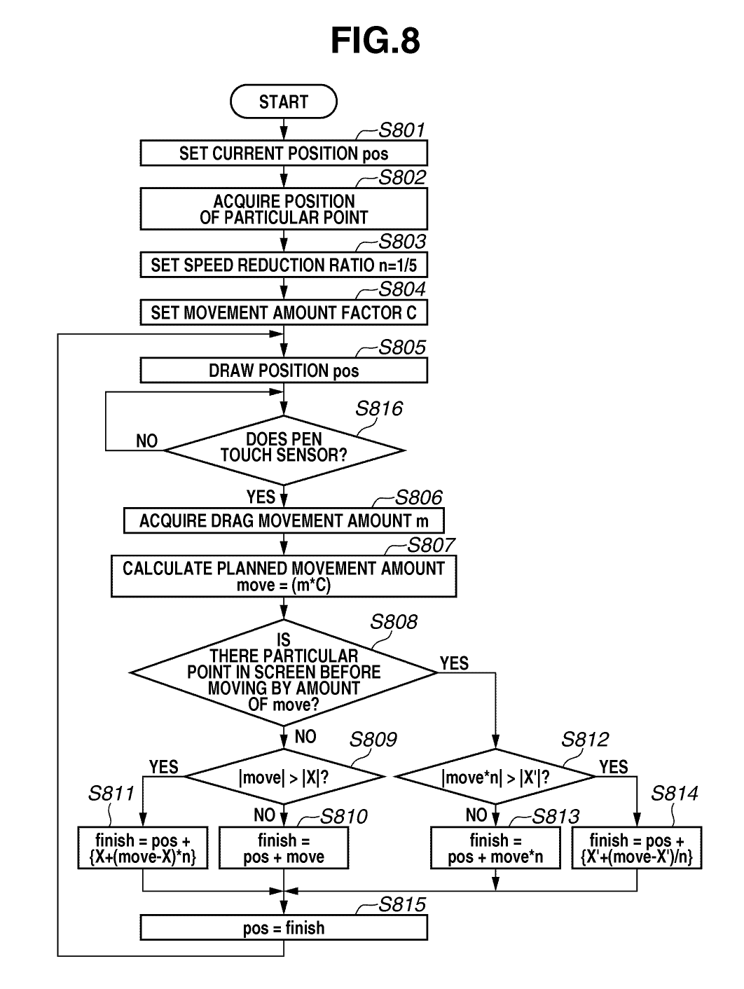

FIG. 8 is a flowchart illustrating an example of processing procedures for the scroll display operation when the user drags the pen on the liquid crystal panel 205. The processing illustrated in FIG. 8 is performed under control of the CPU 101. The procedures in the present exemplary embodiment may be similarly used when the user operates the menu screen which is provided for inputting the camera setting at imaging time and in which generally a plurality of items is displayed and the user selects an arbitrary item therefrom by a selection frame (cursor) as in the first exemplary embodiment.

In FIG. 8, since the processing in steps S801 to S803, S805, and S807 to S814 are almost the same as that in steps S301 to S303, S305, and S307 to S314 in FIG. 3 described in the first exemplary embodiment, the description thereof is omitted.

In step S804, the CPU 101 sets the movement amount factor C. The movement amount factor C is set to 1 when the scroll amount is equal to a pen dragging distance, and is set to a value larger than 1 when the scroll amount is larger than the pen dragging distance. Conversely, the movement amount factor C is set to a value smaller than 1 when the scroll amount is smaller than the pen dragging distance. In the present exemplary embodiment, the movement amount factor C is set to 1 because an image follows the pen.

In step S816, the CPU 101 waits until it is detected that the pen touches the liquid crystal panel 205. If it is detected that the pen touches the liquid crystal panel 205 (YES in step S816), the CPU 101 advances the processing to the next step, step S806, and the subsequent steps.

In step S806, the CPU 101 detects a distance m, over which the pen moves with its tip on the liquid crystal panel 205, from the touch sensor and acquires information about the distance m. The CPU 101 can acquire the information about the movement distance m multiple times at a very short time interval even when the pen is held on the liquid crystal panel 205. In the information acquired in step S806, the distance from the position where the information is acquired last to the position where the information is to be acquired is the movement distance m. The distance m is a positive value when dragging is performed from right to left, and is a negative value when dragging is performed from left to right.

In step S807, the CPU 101 calculates the planned movement amount “move” by multiplying the movement amount factor C by the distance m. In the present exemplary embodiment, the planned movement amount “move” is equal to the distance m because the movement amount factor C is set to 1.

When the processing in step S810, S811, S813, or S814 is terminated, in step S815, the CPU 101 sets the current position “pos” to the movement destination “finish”. After that, in step S805, the CPU 101 draws the position “pos” again and, if there is no particular point in the screen, shows the scroll animation through re-drawing in such a way that the images follow the pen. If there is the particular point in the screen, the CPU 101 scrolls the images at the reduced speed in relation to the pen movement distance.

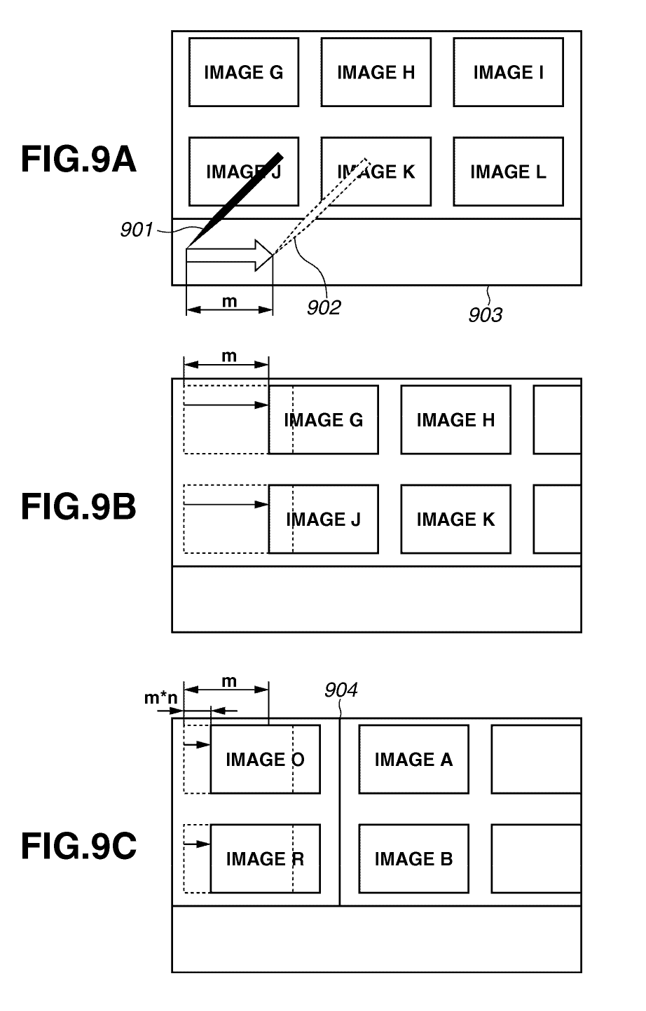

FIG. 9A illustrates an example in which the user drags the pen from a position 901 to a position 902 in an area 903. In this case, when the CPU 101 advances the processing to step S810, the displayed images also move the same distance of m as illustrated in FIG. 9B.

On the other hand, when the user drags the pen at the distance m in the same way as in the example illustrated in FIG. 9A while a particular point 904 is included in the screen and, as a result, the CPU 101 advances the processing to step S813, the displayed images move a distance of m*n as illustrated in FIG. 9C.

As described above, during the user's drag operation, the screen scrolls at the reduced speed in the present exemplary embodiment when a particular position such as the particular point is displayed in the display screen. Thus, the present exemplary embodiment allows the user to scroll the screen with no need to perform the operation again or to perform a special operation.

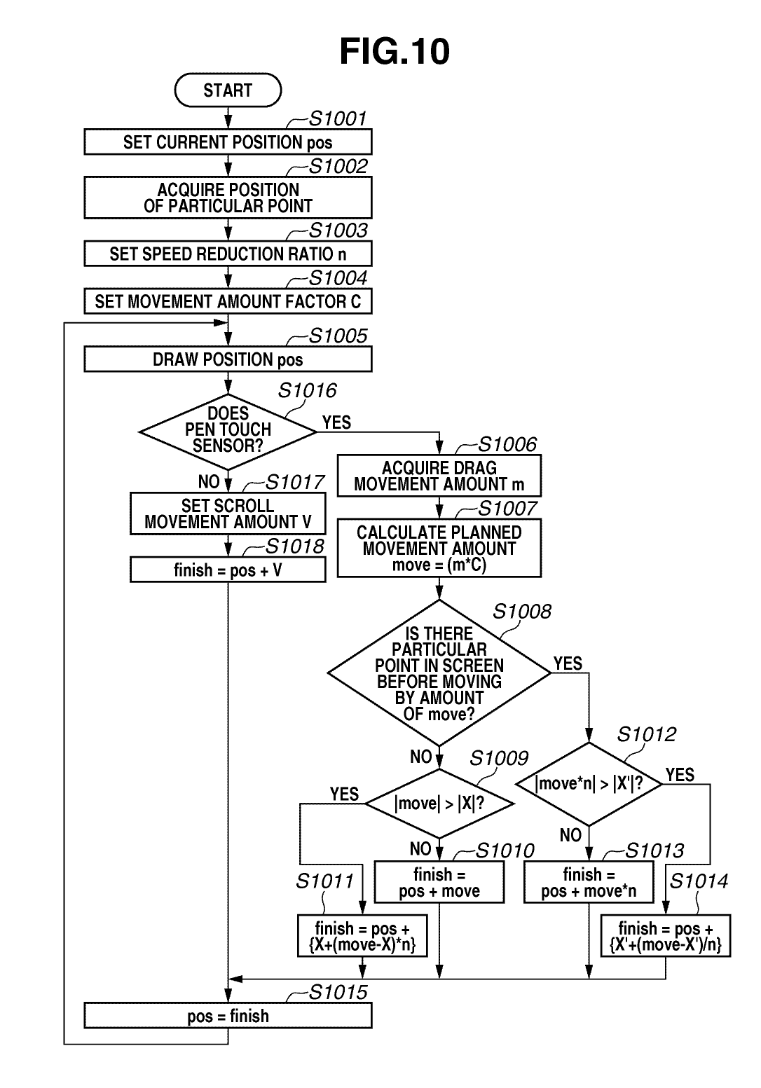

With reference to FIG. 10, the following describes a third exemplary embodiment using an example in which an automatic scroll function is added to the second exemplary embodiment. The configuration of a digital video camera according to the present exemplary embodiment is similar to the digital video camera illustrated in FIG. 1 and FIG. 2 and therefore the description thereof is omitted.

FIG. 10 is a flowchart illustrating an example of processing procedures for the scroll display operation when the user drags the pen on the liquid crystal panel 205 in the present exemplary embodiment. The processing illustrated in FIG. 10 is performed under control of the CPU 101. The procedures in the present exemplary embodiment may be similarly used when the user operates the menu screen which is provided for inputting the camera setting at imaging time and in which generally a plurality of items is displayed and the user selects an arbitrary item therefrom by a selection frame (cursor) as in the first exemplary embodiment.

Because the processing in steps S1001 to S1014 are almost the same as that in steps S801 to S814 in FIG. 8 described in the second exemplary embodiment, the description thereof is omitted.

In step S1016, the CPU 101 determines whether it is detected that the pen touches the liquid crystal panel 205. If it is determined that the touch of the pen is detected (YES in step S1016), the CPU 101 advances the processing to step S1006. Whereas if not determined so (NO in step S1016), the CPU 101 advances the processing to step S1017.

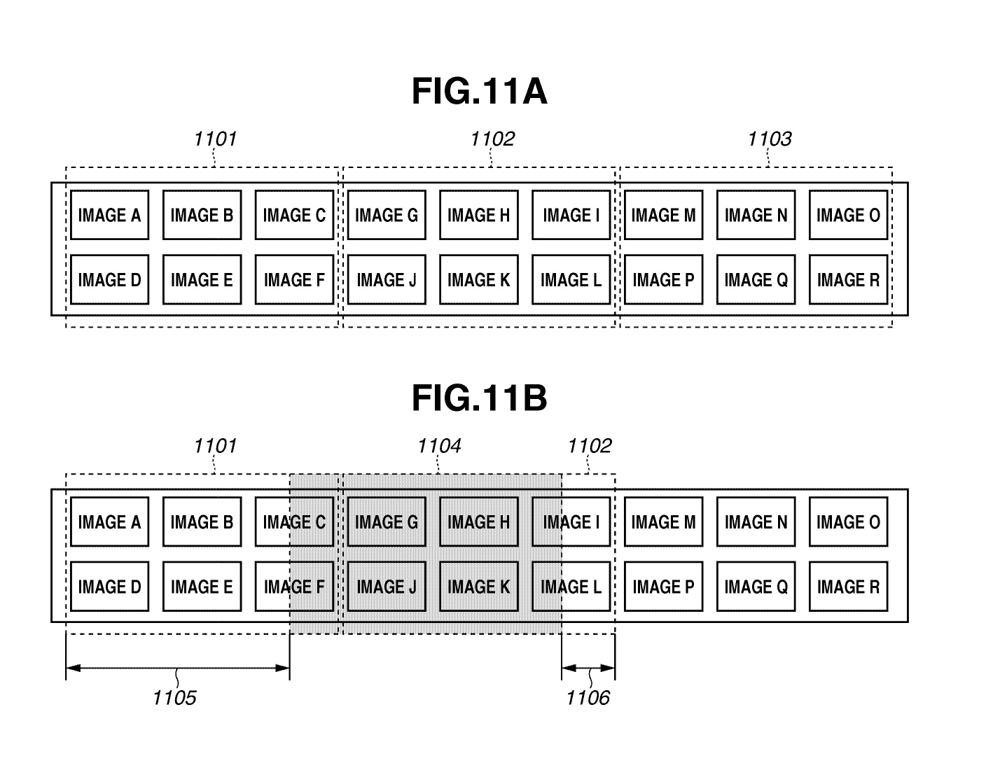

In step S1017, the CPU 101 determines a predetermined scroll position to which the position “pos” is nearest, detects on which side the predetermined scroll position is displayed, and calculates a movement amount V. The predetermined scroll position refers to a position at which the six images fit properly in the screen as illustrated in screens 1101, 1102, and 1103 in FIG. 11A.

For example, when the pen is moved away from the liquid crystal panel 205 with the screen scrolled to the position of a screen 1104 illustrated in FIG. 11B, the CPU 101 compares a distance 1105 to the position of the screen 1101 with a distance 1106 to the position of the screen 1102 and sets the value of the movement amount V so that the screen moves to the nearer position. In the example illustrated in FIG. 11B, because the distance 1106 is shorter, the CPU 101 sets the movement amount V so that the screen moves to the position of the screen 1102 that is determined as the screen at the predetermined scroll position. The movement amount V is a positive value if the nearer predetermined scroll position is on the right side, and is a negative value if the nearer predetermined scroll position is on the left side.

Next, in step S1018, the CPU 101 adds the movement amount V set in step S1017 to the value of the current position “pos” to calculate the movement destination “finish”. Then in step S1015, the CPU 101 replaces the current position “pos” with the movement destination “finish” and returns to step S1005 to change the display contents. According to the above-described processing, the scroll animation is performed to the predetermined position. If the current position “pos” is exactly at the predetermined scroll position, the movement amount V is 0 and the display contents remain unchanged and therefore no scroll animation is performed.

As described above, the present exemplary embodiment prevents the user's drag operation from stopping the screen from at a position where a part of the items is hidden and difficult to view.

The following describes a fourth exemplary embodiment using an example in which a blank is inserted in a particular point when the particular point comes into the screen while performing the operation described in the first exemplary embodiment. The configuration of a digital video camera according to the present exemplary embodiment is similar to the digital video camera illustrated in FIG. 1 and FIG. 2 and therefore the description thereof is omitted.

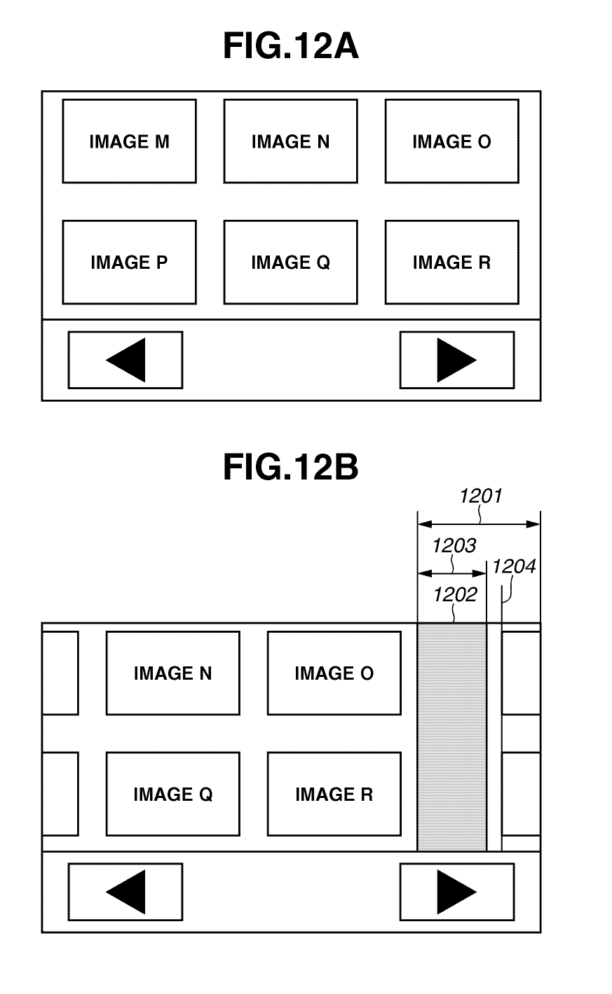

FIG. 12A illustrates an example of a screen immediately before the particular point appears on the screen. FIG. 12B illustrates an example of a screen on which the particular point appears after the user performs the button operation.

The present exemplary embodiment is similar to the first exemplary embodiment in that the screen is scrolled by one screen when the screen is moved with no particular point in the screen. On the other hand, when the screen is moved with the particular point in the screen, the screen is scrolled by the movement amount calculated by multiplying one screen by the speed reduction ratio n. The resulting screen is the one illustrated in FIG. 12B.

In the example illustrated in FIG. 12B, a distance 1201 represents the scroll amount calculated by multiplying one screen by the speed reduction ratio n. In this case, a blank 1202 with a width 1203 is inserted at the particular point. The width 1203 is set to an amount that allows an end 1204 of the next item to be displayed on the screen when the screen is scrolled by the distance 1201. By inserting the blank 1202 in such a manner that the end 1204 of the next item is displayed on the screen after the screen is moved by the scroll amount multiplied by the reduction ratio, the user can recognize not that the screen cannot be scrolled any more, but that the screen can be scrolled further.

In the present exemplary embodiment described above, the blank area is provided at the particular point that makes the user understand that the particular point has been reached.

The present invention is applicable also when the screen is scrolled at a movement speed according to an operation amount (rotation speed) of a rotation operation performed on a rotation operation member. In this case, even if in the same operation amount (rotation amount, rotation speed), the movement speed (scroll speed) of the screen including the end point is set slower than that of the screen not including the end point. Further, such a configuration is not limited to a rotation operation member. More specifically, when the screen is scrolled at a movement speed (or movement amount) according to the operation amount, the movement speed (scroll speed) on the screen including the end point can be set slower than that of the operation on the screen not including the end point.

The CPU 101 can be controlled by one piece of hardware or by a plurality of hardware pieces that share the processing for controlling the entire apparatus.

Although the above-described exemplary embodiments describe an example in which the present invention is applied to a digital video camera, the present invention is not limited to the digital video camera but may be applied to any display control apparatus capable of displaying and scrolling the display objects in a particular order. More specifically, the present invention is applicable to a personal computer, a personal digital assistant (PDA), a mobile phone, a portable image viewer, a printer device with a display, a digital photo frame, a music player, a game machine, and an electronic book reader.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-007157 filed Jan. 17, 2011, which is hereby incorporated by reference herein in its entirety.

What is claimed is:

1. A display control apparatus comprising:
a display control unit configured to control a display unit to display a display object in a particular order;
a scroll control unit configured to perform control to scroll the display object displayed by the display control unit by a movement amount according to an operation amount of an operation member which is a touch sensor or a rotation operation member; and
a determination unit configured to determine the movement amount that the display object is scrolled which is controlled by the scroll control unit so that the movement amount according to the operation amount is smaller in a case where a particular position as a break in the particular order is included in a screen displayed on the display unit than in a case where the particular position is not included therein.

2. The display control apparatus according to claim 1, wherein the particular position is a position where a leading end and a trailing end are joined if the display object is scrolled for cyclic display.

3. The display control apparatus according to claim 1, wherein the particular position is a position where items of the display object are switched.

4. The display control apparatus according to claim 1, wherein the display control unit displays the particular position in an identifiable manner.

5. The display control apparatus according to claim 4, wherein the display control unit displays the particular position with a blank area.

6. The display control apparatus according to claim 5, wherein the display control unit changes a size of the blank area according to a position, to which the particular position is moved, and displays the blank area.

7. The display control apparatus according to claim 1, wherein if the particular position is not included in the screen displayed on the display unit and if a position to which the screen is moved is not a predetermined scroll position, the scroll control unit moves the screen to the predetermined scroll position.

8. A method for controlling a display control apparatus, the method comprising:
controlling a display unit to display a display object in a particular order;
performing control to scroll the displayed display object by a movement amount according to an operation amount of an operation member which is a touch sensor or a rotation operation member; and
determining the movement amount the displayed display object is scrolled so that the movement amount according to the operation amount is smaller in a case where a particular position as a break in the particular order is included in a screen displayed on the display unit than in a case where the particular position is not included therein.

9. A non-transitory computer-readable storage medium storing a program which when loaded into a computer and executed causes the computer to perform a method for controlling a display control apparatus, the method comprising:
controlling a display unit to display a display object in a particular order;
performing control to scroll the displayed display object by a movement amount according to an operation amount of an operation member which is a touch sensor or a rotation operation member; and
determining the movement amount the displayed display object is scrolled so that the movement amount according to the operation amount is smaller in a case where a particular position as a break in the particular order is included in a screen displayed on the display unit than in a case where the particular position is not included therein.
